(19) United States
(12) Patent Application Publication
(10) Pub. No.: US 2006/0055390 A1
(43) Pub. Date: Mar. 16, 2006

(54) Circuit arrangement with a level shifter and a voltage regulator

(75) Inventor: Marcus Nuebling, Olching-Esting (DE)

Correspondence Address: Harold C. Moore;Maginot, Moore & Beck, Bank One Tower, 111 Monument Circle, Suite 3000, Indianapolis, IN, 46204, US

(73) Assignee: Infineon Technologies AG, Munchen (DE)

(21) Appl. No.: 11/217,076

(22) Filed: Aug. 30, 2005

(30) Foreign Application Priority Data
Aug. 30, 2004 (DE) 10 2004 041 927.2

(51) Int. Cl. G05F 3/04

(52) U.S. Cl. 323/311

(57) ABSTRACT

A circuit arrangement comprises a level shifter which is supplied with a first signal and which provides a level-shifted second signal, at least one load which is supplied with the second signal as an actuating signal, at least one voltage regulator, for providing a supply voltage for the at least one load, which has a connection for supplying a signal that sets the current yield of the voltage regulator arrangement and which is supplied with a signal, as a setting signal, that is dependent on the at least one first signal.

### BACKGROUND

The present invention relates to a circuit arrangement with a level shifter for actuating a load and with a voltage regulator for supplying power to the load.

Level shifters are used, in a sufficiently well known manner, to convert a first signal taking a first potential as a reference into a second signal which takes a higher second potential as a reference. Various refinements of level shifters are described in U.S. Pat. No. 5,539,334 or in U.S. 2003/0107425A1, for example.

By way of example, level shifters are used when actuating power transistors which are connected up as “high-side switches”, and serve to convert a signal taking a first potential, for example reference-ground potential, as a reference into an actuating signal with a level suitable for actuating the transistor. As is known, a transistor is connected up as a high-side switch when the load path of the transistor is connected in series with the load between terminals for supply potentials and when the load path of the transistor in this case is situated between the more positive of the two supply potentials and the load. When an n-channel MOSFET is used as the power transistor, the transistor needs to be turned on by providing an actuating voltage which is at least the value of the threshold voltage of the transistor above the potential at the node which is common to the load and to the transistor.

A circuit arrangement having an n-channel MOSFET used as a high-side switch and a level shifter which converts an actuating signal taking reference-ground potential as a reference into a suitable actuating signal for a driver stage which actuates the high-side switch is described in U.S. Pat. No. 5,933,034, for example. In the case of this known circuit, the supply voltage for the driver stage is generated by a “bootstrap circuit” and takes the potential at a node which is common to the high-side switch and to the load as a reference.

Depending on the specific refinement of the driver stage and possibly further logic circuits for actuating a high-side switch, it may be necessary to use a supply voltage generated by a bootstrap circuit, for example, to generate a regulated supply voltage, which makes it necessary to use a voltage regulator.

In this context, this voltage regulator should be proportioned such that it draws the least possible quiescent current, so as not to place an unnecessary load on the voltage source, which is in the form of a bootstrap circuit, for example, but such that, if required, it has a sufficient current yield to provide the required supply voltage reliably even when the circuit connected to the regulator draws a large current, i.e. to correct changes in the power consumption of the connected circuit quickly.

In principle, the demand for a low quiescent current consumption and the demand for a high current yield conflict with one another in voltage regulators. However, there are voltage regulators in which the current yield is adjusted adaptively on the basis of the instantaneous current requirement of the connected load, in order to increase the current yield, or to reduce the output resistance of the regulator, when the load is drawing large currents, and thereby to keep the level of the supply voltage provided constant even when there is a large current requirement. A differential amplifier with adaptive adjustment of the current yield which is used as a voltage regulator is described, by way of example, in Degrauwe, Marc et al: “Adaptive Biasing CMOS Amplifiers”, IEEE Journal of Solid State Circuits, Vol. SC-17, No. 3, June 1982, pages 522-528, FIG. 2. In the case of this amplifier, the fundamental current (bias current) in a differential amplifier is adjusted on the basis of the current requirement at the output of the voltage regulator.

A drawback of adaptive adjustment of the current yield in a voltage regulator on the basis of the current requirement of a load connected to the output of the regulator is that adjustment cannot take place until a change in the current requirement has actually occurred, which makes correcting load changes slow.

### SUMMARY

It is an aim of the present invention to provide a circuit arrangement having a level shifter for actuating a load and having a voltage regulator for supplying voltage to the load in which the voltage regulator reacts quickly to changes in the current drawn by the load.

In one embodiment, the inventive circuit arrangement has the following features:
a level shifter which is supplied with a first signal and which provides a level-shifted second signal,
at least one load which is supplied with the second signal as an actuating signal,
at least one voltage regulator, for providing a supply voltage for the at least one load, which has a connection for supplying a signal that sets the current yield of the voltage regulator arrangement and which is supplied with a signal, as a setting signal, that is dependent on the at least one first signal.

The invention makes use of the insight that the current drawn by the load which is supplied with power by the voltage regulator is dependent on the first signal or on the level-shifted second signal which actuates the load, with the current drawn being particularly high when the signal level of the first or second signal changes, for example. In the case of the inventive circuit arrangement, the voltage regulator is actuated predictively by means of at least one signal which is dependent on the first signal, in order to increase the current yield of the voltage regulator during such time periods of increased current drawn by the load. The load supplied with power by the voltage regulator is an integrated actuating circuit for a high-side switch, for example. Such integrated actuating circuits, which are normally implemented in CMOS technology, are known to cause a severe increase in the current at the output of the voltage regulator as a result of parallel-path currents during switching.

By way of example, the load is a driver circuit or part of a driver circuit for a power transistor used as a high-side switch. It is the task of such a driver circuit to actuate the power transistor as stipulated by the second signal, which is derived from the first signal. In this case, the current drawn by the driver circuit is largest when a change in the switching state of the power transistor is to be made on the basis of the second signal.

In one exemplary embodiment, the level shifter generates at least one differential signal from the first signal which is supplied to an output stage in the level shifter for generating the second signal. The at least one differential signal which is dependent on the first signal is supplied to the voltage regulator in this case. The differential signal generated from the first signal has a signal pulse after a respective rising or falling edge of the first signal and brings about an increased current yield from the voltage regulator for the duration of this signal pulse. The differential signal is generated in the level shifter preferably following adaptation to the period of increased current requirement in the load after an edge of the first or second signal, in order to increase the current yield from the voltage regulator for this period of increased current requirement.

To generate the load supply voltage, the at least one voltage regulator is supplied with a regulator supply voltage having a lower supply potential and an upper supply potential, the voltage regulator being able to be designed, on the basis of the instance of application, to generate the load supply voltage taking the lower supply potential as a reference or taking the upper supply potential as a reference.

The at least one voltage regulator preferably has a voltage limiting element via which the load supply voltage can be tapped off, and a resistor arrangement, connected in series with the voltage limiting element, which has a variable resistance and which is supplied with the at least one setting signal. The series circuit containing the voltage limiting element and the resistor arrangement is connected between terminals for the regulator supply voltage in this case.

By way of example, the voltage limiting element is a zener diode, and the resistor arrangement comprises a resistor element and a switch arrangement, for example, which is connected in parallel with the resistor element and which is actuated as stipulated by the at least one setting signal.

### BRIEF DESCRIPTION OF THE DRAWINGS

The present invention is explained in more detail below using exemplary embodiments with reference to figures.

FIG. 1 shows a first exemplary embodiment of a circuit arrangement with a level shifter, a load actuated by the level shifter and a voltage regulator for supplying voltage to the load.

FIG. 2 shows an exemplary embodiment of a voltage regulator with adjustable current yield.

FIG. 3 shows a second exemplary embodiment of a circuit arrangement with a level shifter, a load actuated by the level shifter and a voltage regulator for supplying voltage to the load.

FIG. 4 shows a modification of the circuit arrangement shown in FIG. 3 with a level shifter shown in detail.

FIG. 5 illustrates the manner of operation of the level shifter shown in FIG. 4 with reference to time profiles for selected signals arising in the level shifter.

FIG. 6 shows an exemplary embodiment of an inventive circuit arrangement with two voltage regulators, one of which generates a load supply voltage taking an upper supply potential as a reference and another of which generates a load supply voltage taking a lower supply potential as a reference.

FIG. 7 shows examples of circuit implementation for the voltage regulators shown in FIG. 5.

FIG. 8 illustrates an example of application of the inventive circuit arrangement in a circuit for actuating a power transistor used as a high-side switch.

In the figures, unless stated otherwise, identical reference symbols denote the same circuit components and signals with the same meaning.

### DESCRIPTION

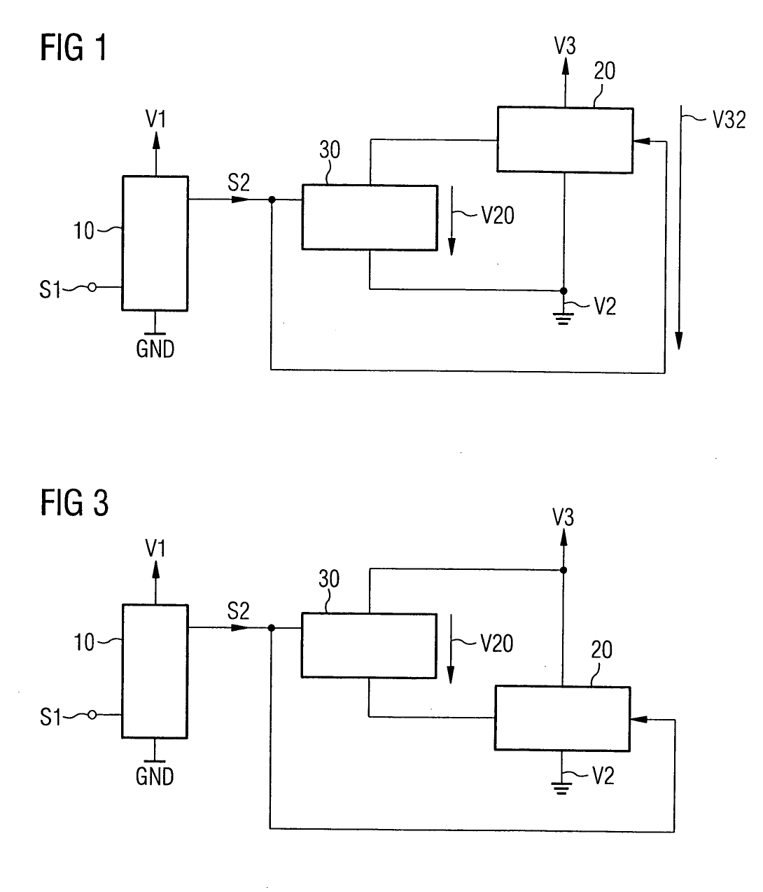

FIG. 1 shows a block diagram of a first exemplary embodiment of a circuit arrangement based on the invention. The circuit arrangement comprises a level shifter 10 which is connected between a reference-ground potential GND and a first potential VI and which is supplied with a first signal 81 taking reference-ground potential GND as a reference. The level shifter 10 is designed to convert this first signal 81 taking reference-ground potential GND as a reference into a level-shifted second signal 82 which is supplied as actuating signal to a load circuit 30.

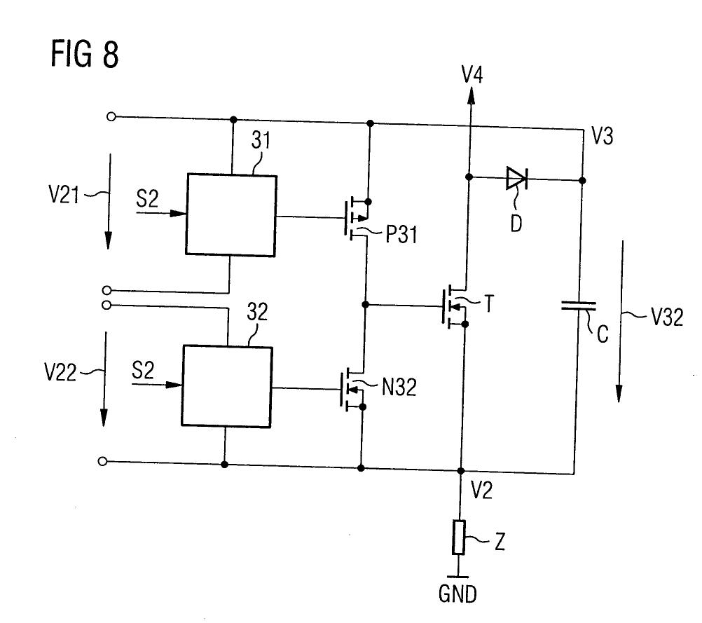

To supply voltage to this load circuit 30, a voltage regulator 20 is provided which is supplied with a regulator supply voltage V32. This regulator supply voltage V32 takes a second potential V2 as a reference, said second potential V2 being the reference-ground potential of the voltage regulator 20. This reference-ground potential V2 of the voltage regulator 20 can vary over time, as will be explained below with reference to FIG. 8, and is different than the reference-ground potential GND of the level shifter 10, at least in terms of timing. The voltage regulator 20 provides a regulated supply voltage V20 for the load 30, said supply voltage taking the reference-ground potential V2 of the voltage regulator 20 as a reference in the example shown in FIG. 1.

In this case, it is the task of the voltage regulator 20 to keep the supply voltage V20 constant at least approximately regardless of the current drawn by the load 30. In order to be able to react to a sudden high current drawn by the load without the supply voltage V20 falling noticeably, the voltage regulator 20 needs to have a high current yield. An enduringly high current yield from a voltage regulator requires a high quiescent current consumption or a high power consumption in the quiescent state even when the current drawn by the load 30 is low, however.

To avoid this problem, the inventive circuit arrangement has provision for the current yield of the voltage regulator 20 to be set according to need using the actuating signal S2 for the load circuit 30. To this end, in the example shown in FIG. 1, the voltage regulator 20 is supplied with the second signal S2, which serves as actuating signal for the load circuit 30.

The invention makes use of the insight that the current drawn by the load circuit 30 which is actuated by the actuating signal S2 is particularly high when there is a change of level in the actuating signal S2. The voltage regulator 20 is therefore designed such that for a prescribed period of time after such a level change in the actuating signal S2 the current yield is increased in order to react to increased current drawn by the load circuit 30.

Voltage regulators, such as the voltage regulator described in Tietze, Schenk: “Halbleiterschaltungs-technik” [Semiconductor circuitry], 11th edition, Springer Verlag, on page 963 in section 16.9, are known sufficiently well to have a current source for providing a fundamental current (bias current) in the voltage regulator, the value of this bias current governing the quiescent current consumption and the current yield of the voltage regulator. A conventional voltage regulator can easily be modified for use in the inventive circuit arrangement shown in FIG. 1 by virtue of the current source which provides the fundamental current (bias current) being an adjustable current source which is supplied with the signal based on the second signal S2 as control signal, in order to increase the fundamental current and as a result to increase the current yield during periods of time in which the load draws an increased current.

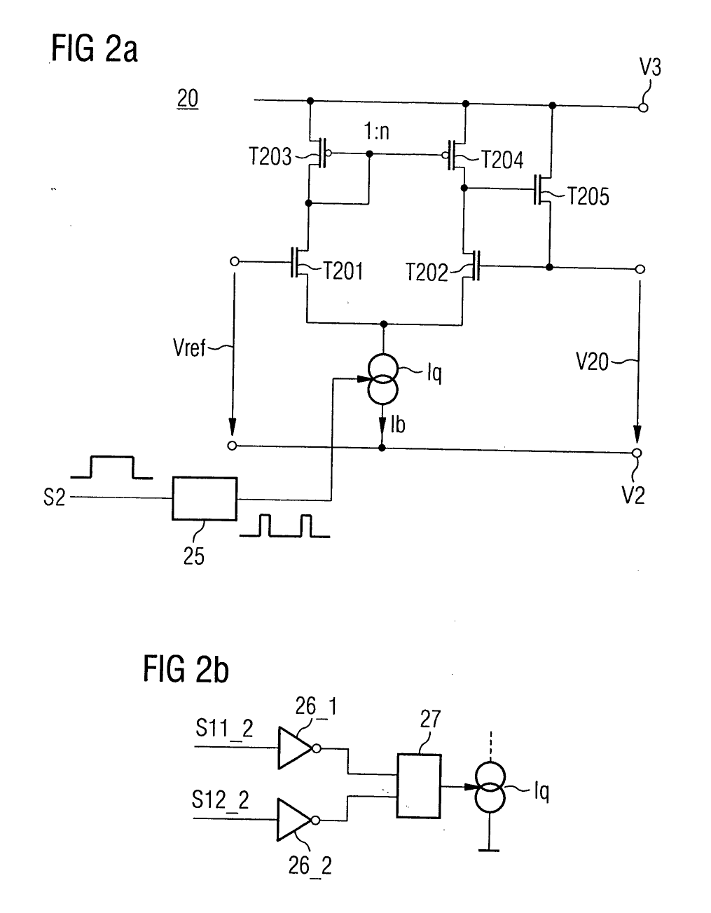

Such a modified voltage regulator with a known fundamental structure is shown in FIG. 2a. The voltage regulator shown has a differential amplifier stage with two transistors T201, T202 and a current source Iq providing the fundamental current. In this arrangement, one of the inputs of the differential amplifier stage T201, T202, Iq, which input is formed by the control connection of the transistor T201, has a reference voltage Vref applied to it which prescribes the value of the regulated supply voltage V20 provided by the voltage regulator. This supply voltage V20 is delivered by an output transistor against the reference-ground potential V2 of the voltage regulator 20. To regulate this supply voltage V20, the second input of the differential amplifier stage, which second input is formed by the control connection of the transistor T202, is connected to the output. The output transistor T205 is actuated via the differential amplifier stage T201, T202 in combination with a current mirror T203, T204. This basic structure of a voltage regulator with a differential amplifier, an output transistor and a current mirror is sufficiently well known.

This basic structure can easily be modified for use in the inventive circuit arrangement by virtue of the current source Iq which provides the fundamental current Ib being actuated on the basis of the second signal S2 such that the fundamental current Ib is increased for a prescribed period of time after a rising or falling edge of the actuating signal S2. To actuate this current source Iq, the example shown in FIG. 2a has an edge detector 25 which generates a signal which generates a signal pulse for a prescribed period of time after each rising and falling edge of the actuating signal S2. This signal actuates the current source Iq in order to increase the fundamental current Ib for the prescribed period of time of the signal pulse after a rising or falling edge of the actuating signal S2.

The supply voltage V20 generated by the voltage regulator 20 may, depending on the requirements of the load 30, either take as a reference the lower supply potential V2, which the regulator supply voltage V32 takes a reference, or this supply voltage V20 can take the upper supply potential V3 of the regulator supply voltage V32 as a reference, as illustrated for the exemplary embodiment of the inventive circuit arrangement in FIG. 3.

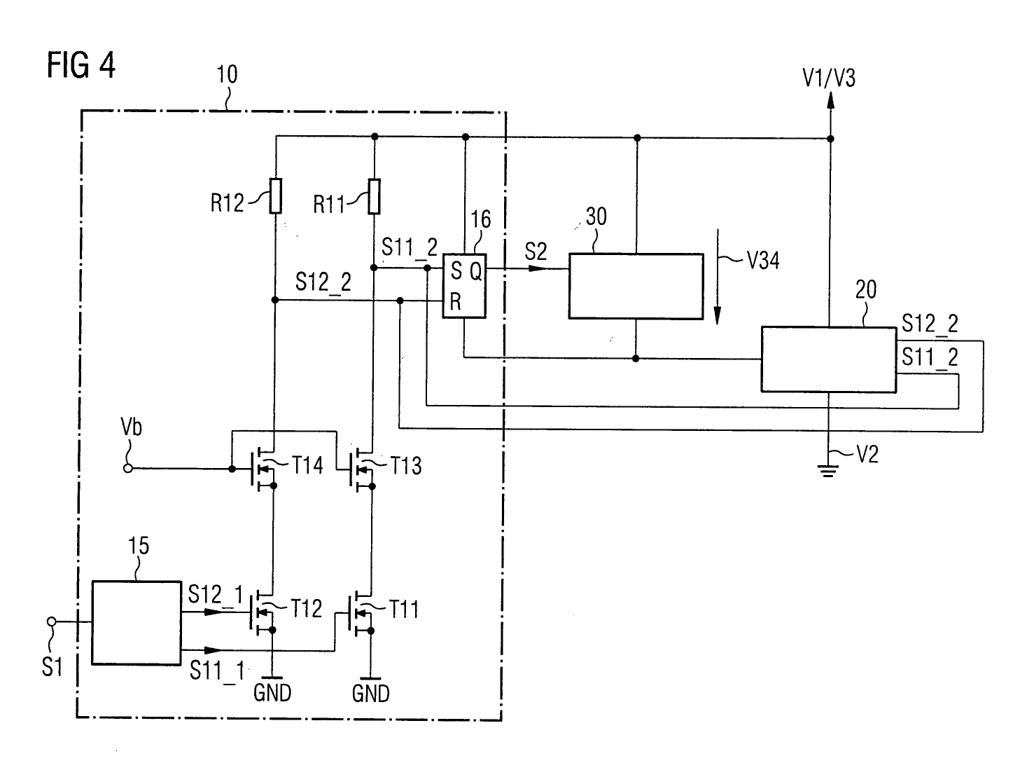

FIG. 4 shows an exemplary embodiment of an inventive circuit arrangement in which the level shifter 10 used is a differential level shifter. The differential level shifter generates differential signals S11_2, S12_2 which each indicate rising and falling edges of the first signal S1 and which are supplied to the voltage regulator 20 directly as setting signals for the current yield.

The level shifter shown has an input stage 15 which is supplied with the first signal S1 and which generates differential signals S11_1, S12_1 from the first signal S1. These differential signals S11_1, S12_1 actuate a first and second transistor T11, T12, whose load paths are connected in series with resistors R11, R12 between the reference-ground potential GND and the first potential V1. The transistors T11, T12 actuated by the differential signals S11_1, S12_1 and the resistors R11, R12 have cascode transistors T13, T14 connected between them which are actuated by a bias voltage Vb and which limit the voltage across the transistors T11, T12. At these nodes which are common to the resistors R11, R12 and to the cascode transistors T13, T14, it is possible to tap off the first and second differential signals S11_2, S12_2 which are supplied to the voltage regulator 20 in order to set the current yield.

In the level shifter 10, these differential signals S11_2, S12_2 are supplied to an output stage 16, which is in the form of an RS flipflop in the example and whose output provides the second signal S2, whose level has been shifted in comparison with the first signal S1. To generate this second signal S2, the first differential signal S11_2 is supplied to the Set input S of the flipflop 16, and the second differential signal S12_2 is supplied to the Reset input of the flip-flop 16.

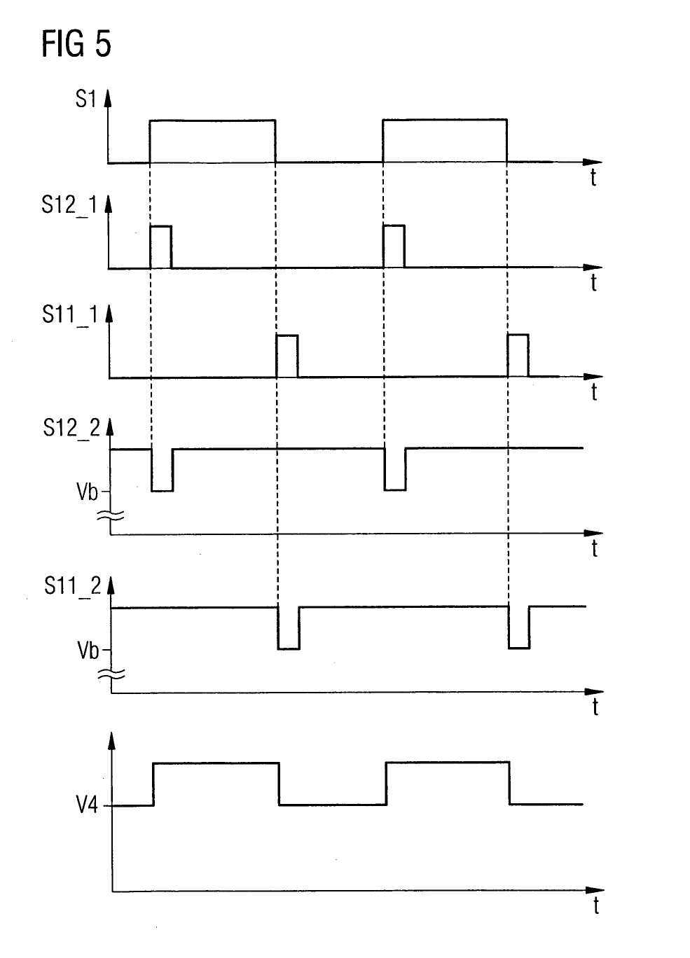

The manner of operation of this level shifter 10 becomes clear from the time profiles shown in FIG. 5 for the first signal S1, for the differential signals S11_1, S12_1 available at the output of the input stage 15, for the first and second differential signals S11_2, S12_2 and for the second signal S2, this timing diagram not taking account of signal propagation times within the level shifter. The input stage 15 is designed such that the differential signal S11_1 supplied to the first transistor T11 has a signal pulse of a prescribed duration after a respective rising edge of the first signal S1, and such that the differential signal supplied to the second transistor T12 has a signal pulse of a prescribed duration after a respective falling edge of the first signal S1.

Turning on the first transistor T11 using the signal pulse S11_1 results in a negative signal pulse of the first differential signal S11_2 for the duration of the signal pulse S11_1, and turning on the second transistor T12 using the signal S12_1 results in a negative signal pulse of the second differential signal S12_2 during the period of the signal pulse S12_1.

The flipflop 16 shown in FIG. 4 is a negative-edge-triggered flipflop which is set or reset upon a respective falling edge of one of the differential signals S11_2, S12_2. In this case, the output at which the second signal S2 is available is the inverting output of the flipflop 16.

It should be pointed out that besides an edge-triggered flipflop it is naturally also possible to use a level-triggered flip-flop.

In the example shown in FIG. 4, the voltage regulator 20 is designed such that its current yield is increased during the period during which the differential signals S11_2, S12_2 each have negative signal pulses. If one considers a voltage regulator with a basic structure as shown in FIG. 2a, the current source Iq providing the fundamental current, with reference to FIG. 2b, could in this case be actuated such that the two differential signals S11_2, S12_2 are respectively inverted and then supplied to an OR gate which actuates the current source. In this case, the current source is designed such that it provides an increased fundamental current during positive signal pulses of the output signal from the OR gate 27. The signals generated by the inverters are signals which take the bias voltage Vb as a reference, for example in line with the differential signals S11_2, S12_2.

In the exemplary embodiment, the supply voltage V34 provided by the voltage regulator 20, which supply voltage takes the upper supply potential V3 of the regulator 20 as a reference, is supplied not only to the load 30 but also to the flipflop 16 used as output stage for the level shifter 10. The first potential V1 of the level shifter 10 and the upper supply potential V3 of the regulator 20 match in the exemplary embodiment.

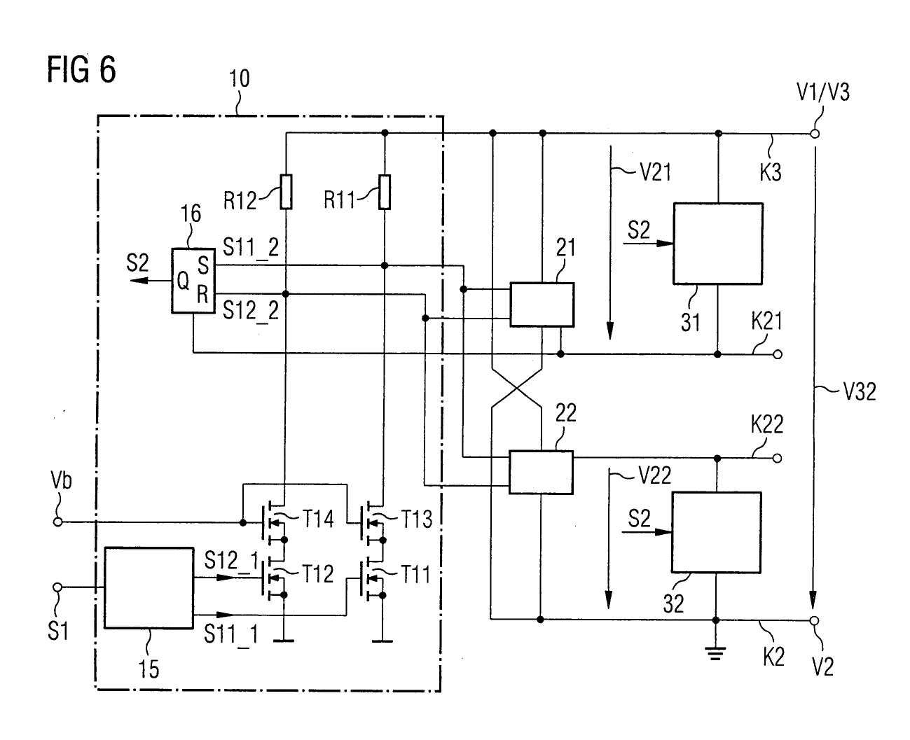

FIG. 6 shows an exemplary embodiment of a circuit arrangement based on the invention in which there are two voltage regulators 21, 22, of which a first voltage regulator 21 provides a first load supply voltage V21 for a first load 21 and from of a second voltage regulator 22 generates a second load supply voltage V22 for a second load 32. In this case, the two regulators 21, 22 are supplied with a regulator supply voltage V32 via supply voltage connections. The first load supply voltage V21 generated by the first regulator 21 takes an upper potential V3 of this regulator supply voltage V32 as a reference in this case, and the second load supply voltage V22 generated by the second regulator 22 takes the lower supply potential V2 of this regulator supply voltage V32 as a reference. In the example, the first load supply voltage V21 is used not only for supplying the first load 31 with power but also for supplying voltage to the flipflop 16 in the level shifter 10. The two voltage regulators 21, 22 are supplied with the differential signals S11_2, S12_2 generated in the level shifter, which are dependent on the first signal S1, in order to set the current yield.

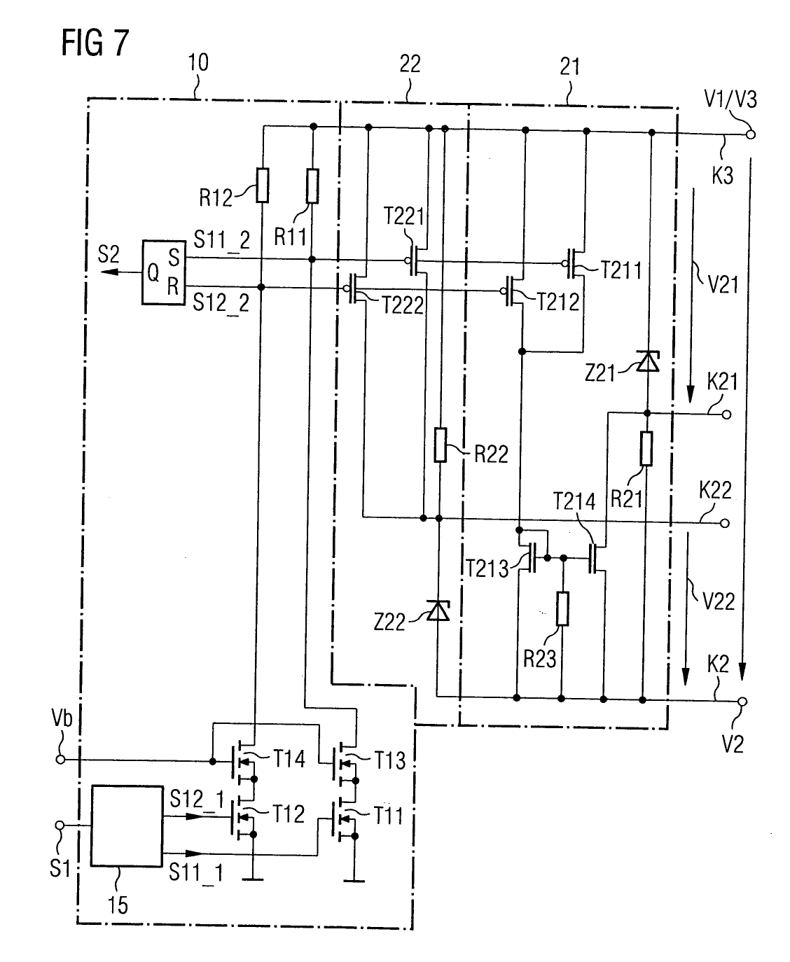

A particularly simple circuit implementation of the voltage regulators 21, 22 shown in FIG. 6 is explained below with reference to FIG. 7.

The two voltage regulators 21, 22 have a series circuit containing a voltage limiting element Z21, Z22 and a resistor arrangement, actuated by the differential signals S11_2, S12_2, with an adjustable resistance. The output voltage of the respective voltage regulator, i.e. the load supply voltage V21, V22, can in this case be tapped off via the respective voltage limiting element Z21, Z22, which is in the form of a zener diode in the example.

The voltage limiting element Z22 of the second voltage regulator 22 is connected between an output terminal K22 of this voltage regulator and a terminal K2 for the lower supply potential V2. The resistor arrangement connected in series with this voltage limiting element Z22 is situated between the output terminal K22 and the terminal K3 for the upper supply potential V3. This resistor arrangement has a nonreactive resistor R22 connected between the terminal K3 for the upper supply potential V3 and the output terminal K22 and a switch arrangement which is connected in parallel with this nonreactive resistor R22 and which is actuated by the differential signals S11_2, S12_2. In the example, this switch arrangement comprises two transistors T221, T222 which are in the form of p-conductive MOSFETs and whose load paths are connected in parallel with the nonreactive resistor R22. In this arrangement, one of these transistors T221 is actuated by the first differential signal S11_2, and the second transistor T222 is actuated by the second differential signal S12_2. Whenever the differential signals assume their quiescent value, which corresponds to a high level, the two transistors T221, T222 are turned off. A load connected between the output terminal K22 and the terminal K2 for the lower supply potential V2 can then be supplied with current exclusively via the nonreactive resistor R22. This nonreactive resistor R22 is chosen such that the current drawn by the voltage regulator 22 during this operating state is small, but the current yield of the voltage regulator 22 during this operating state is likewise correspondingly low.

During the period for which one of the two differential signals S11_2, S12_2 assumes a low level, one of the two transistors T221, T222 is on, as a result of which the nonreactive resistor R22 is essentially shorted and the resistance value of the resistor arrangement is significantly reduced. The current drawn by the voltage regulator 22 is increased during this operating state, but a much larger current can be delivered to the output terminal K22 for supplying a load connected thereto, with this current being limited by the current-carrying capacity of the two transistors T221, T222.

The voltage limiting element Z21 of the first voltage regulator 21 is connected between the terminal K3 for the upper supply potential V3 and an output terminal K21 of the first voltage regulator 21. The resistor arrangement in this first voltage regulator 21 comprises a nonreactive resistor R21 which is connected in series with the voltage limiting element Z21 and between the output terminal K21 and the terminal K2 for the lower supply potential V2. A switch arrangement connected in parallel with this nonreactive resistor R21 comprises a first transistor T214 whose load path is connected in parallel with the nonreactive resistor R21 and which is actuated via two transistors T211, T212, which correspond to the transistors T221, T222 in the second regulator, a further transistor T213 connected up as a diode and a resistor R23. The transistor T213 connected up as a diode is in this case connected in series with the load paths of the transistors T211, T212 between the terminals K3, K2 for the regulator supply voltage V32.

This transistor T213 forms a current mirror with the transistor T214, this transistor T213 being optional if there is a resistor R23 for actuating the transistor T214. By contrast, it is possible to dispense with the resistor R23 when the current mirror transistor T213 is present.

A respective one of the two transistors T211, T212 is actuated by one of the differential signals S11_2, S12_2. If one of the two transistors T211, T212 is turned on in this voltage regulator 21, the flow of current through one of these two transistors T211, T212 results in a voltage drop across the resistor R23 which turns on the transistor T214 connected in parallel with the resistor R21 in order to reduce the resistance value of the resistor arrangement R21, T214 connected in series with the voltage limiting element Z21 and to increase the current yield of this first voltage regulator 21 as a result.

An example of application for the previously explained circuit arrangement with a level shifter and a voltage regulator with controlled current yield is explained below with reference to FIG. 8. In the example of application, the previously explained load circuits 31, 32, which are supplied with the first load supply voltage V21 of the first voltage regulator and with the second load supply voltage V22 of the second voltage regulator, are part of a driver circuit for actuating a power transistor T used as a high-side switch. The load path of this power transistor T is connected in series with a load Z between a supply potential V4 for the load Z and reference-ground potential GND, the transistor being situated between the supply potential V4 and the load Z. A bootstrap circuit with a diode D and a capacitor C, which are connected in series with one another and in parallel with the load path of the power transistor T, ensures that the regulator supply voltage V32 is provided. This regulator supply voltage V32 is present across the capacitor C. In this case, the lower supply potential V2 is the potential on the node which is common to the power transistor T and to the load Z, and in the example corresponds to the source potential of the power transistor T. This source potential V2 varies on the basis of the switching state of the transistor T between approximately reference-ground potential GND when the transistor is off and approximately supply potential V4 when the transistor T is on.

The circuits 31, 32 supplied by the load supply voltages V21, V22 are actuating circuits for driver transistors P31, N32 in the driver circuit. The transistor P31 actuated by the circuit 31 is a p-channel transistor P31 in the example, whose load path is connected between the drain connection and the gate connection of the power transistor T. The transistor N32 actuated by the second circuit 32 is an n-channel transistor which is connected between the gate connection and the source connection of the power transistor T. The series circuit comprising the two driver transistors P31, N32 is in parallel with the bootstrap capacitor C used as a supply voltage source. The control circuits 31, 32 are designed such that, as stipulated by the actuating signal S2 provided by the level shifter, only a respective one of the two driver transistors P31, N32 is on at a time. When the transistor P31 is on and the transistor N32 is off, the power transistor T is turned on, and the lower supply potential V2 of the voltage regulators (cf. FIGS. 6 and 7) then corresponds approximately to the supply potential V4 of the load Z, and the upper supply potential V3 is above this potential by the value of the bootstrap voltage V32. When the transistor P31 is off and the transistor N32 is on, the power transistor T is off, as a result of which the lower supply potential V2 corresponds approximately to reference-ground potential GND and the bootstrap capacitor C is charged via the diode D. The regulator supply voltage V32 thus corresponds essentially to the supply voltage V4 minus the voltage drop across the diode D.

The control circuits 31, 32 and the driver transistors P31, N32 are preferably in the form of an integrated circuit. When the power transistor is turned on or off as stipulated by the actuating signal S2, the changing reference-ground potential V2 for the supply voltage V21, V22 may result in capacitive charge reversal currents in the integrated circuits, which currents result in increased drawn current by the control circuits 31, 32 during the actual switching operation. This increased current consumption is equalized in the inventive circuit arrangement by the voltage regulator actuated on the basis of the first or second signal S1, S2, said voltage regulator having an increased current yield after rising or falling edges of the actuating signal S2.

### List of Reference Symbols

C Bootstrap capacitor
D Bootstrap diode
GND Reference-ground potential
P31, N32 Driver transistors
R11, R12 Resistors
R21, R22 Resistor
R23 Resistor
RS Flip-flop
S1 First signal
S11_1, S12_1 Differential signals
S11_2, S12_2 Differential signals
S2 Second signal, actuating signal
T Power transistor, high-side switch
T11, T12 Input transistors in the level shifter
T13, T14 Cascode transistors
T201, T202, T205 n-channel transistors
T203, T204 p-channel transistors
T211, T212 p-channel transistors
T213, T214 n-channel transistors
T221, T222 p-channel transistors
V1 First potential
V2, V3 Regulator supply potentials
V20, V21, V22 Supply voltages
V32 Regulator supply voltage, bootstrap voltage
Vref Reference voltage source
Z Load
Z21, Z22 voltage limiting elements, zener diodes
10 Level shifter
15 Input stage of the level shifter
16 Output stage of the level shifter
25 Edge detector
30 Load
21, 22 voltage regulator
31, 32 load circuit, control circuit

1-9. (canceled)

10. A circuit arrangement comprising:
a level shifter configured to receive a first signal and provide a level-shifted second signal;
at least one load configured to receive the second signal as an actuating signal; and
at least one voltage regulator operable to provide a supply voltage for the at least one load, the at least one voltage regulator configured to receive at least one setting signal that sets the current yield of the voltage regulator, wherein the setting signal is dependent on the first signal.

11. The circuit arrangement of claim 10 wherein the level shifter is operable to generate at least one differential signal from the first signal which is supplied to an output stage for generating the second signal, the at least one voltage regulator being supplied with the at least one differential signal.

12. The circuit arrangement of claim 11 wherein the level shifter is operable to generate a first differential signal and a second differential signal from the first signal, and wherein the first differential signal and the second differential signal are supplied to the at least one voltage regulator.

13. The circuit arrangement of claim 10 wherein the at least one voltage regulator is supplied with a regulator supply voltage having a lower supply potential and an upper supply potential, the voltage regulator providing a load supply voltage for the at least one load taking the lower supply potential or the upper supply potential as a reference.

14. The circuit arrangement of claim 13 wherein the at least one voltage regulator comprises
a voltage limiting element, wherein the load supply voltage can be provided via the voltage limiting element; and
a resistor arrangement connected to the voltage limiting element, the resistor arrangement having a variable resistance and supplied with the at least one setting signal.

15. The circuit arrangement of claim 14 wherein the voltage limiting element and the resistor arrangement are connected between terminals for the regulator supply voltage.

16. The circuit arrangement of claim 15 wherein the voltage limiting element is a zener diode.

17. The circuit arrangement of claim 15 wherein the resistor arrangement includes a resistor element and a switch arrangement, wherein the switch arrangement is connected in parallel with the resistor element and actuated as stipulated by the at least one setting signal.

18. The circuit arrangement of claim 10 wherein the load is part of a driver circuit for a power transistor connected up as a high-side switch.

19. The circuit arrangement of claim 13 wherein the load is part of a driver circuit for a power transistor connected up as a high-side switch.

20. The circuit arrangement of claim 19 further comprising a bootstrap circuit for providing the regulator supply voltage.

21. A method of actuating a load and supplying voltage to a load in a circuit arrangement including a level shifter and at least one voltage regulator, the method comprising:
delivering a first signal to the level shifter, wherein the level shifter is configured to provide a level-shifted second signal;
delivering the second signal to the load, wherein the load is configured to receive the second signal as an actuating signal;
providing a supply voltage for the load from the at least one voltage regulator; and
delivering at least one setting signal that sets the current yield of the at least one voltage regulator, wherein the setting signal is dependent on the first signal.

22. The method of claim 21 wherein delivering a first signal to the level shifter further comprises generating at least one differential signal from the first signal which is supplied to an output stage for providing the second signal, and further comprising supplying the at least one voltage regulator with the at least one differential signal.

23. The method of claim 22 wherein the level shifter generates a first differential signal and a second differential signal from the first signal, and wherein the first differential signal and the second differential signal are supplied to the at least one voltage regulator.

24. The method of claim 21 further comprising the step of supplying the at least one voltage regulator with a regulator supply voltage having a lower supply potential and an upper supply potential, wherein the voltage regulator provides a load supply voltage for the load using the lower supply potential or the upper supply potential as a reference.

25. The circuit arrangement of claim 21 wherein the load is part of a driver circuit for a power transistor connected up as a high-side switch.

26. A circuit arrangement comprising:
a level shifter configured to receive a first signal and provide a level-shifted second signal;
at least one load configured to receive the second signal as an actuating signal; and
at least one voltage regulator operable to provide a supply voltage for the at least one load, the at least one voltage regulator including a connection configured to supply a setting signal that sets the current yield of the voltage regulator, wherein the setting signal is dependent on the first signal.

27. The circuit arrangement of claim 26 wherein the level shifter is operable to generate at least one differential signal from the first signal which is supplied to an output stage for generating the second signal, the at least one voltage regulator being supplied with the at least one differential signal.

28. The circuit arrangement of claim 27 wherein the level shifter is operable to generate a first differential signal and a second differential signal from the first signal, and wherein the first differential signal and the second differential signal are supplied to the at least one voltage regulator.

29. The circuit arrangement of claim 26 wherein the at least one voltage regulator is supplied with a regulator supply voltage having a lower supply potential and an upper supply potential, the voltage regulator providing a load supply voltage for the at least one load using the lower supply potential or the upper supply potential as a reference.
